(19) United States
(12) Patent Application Publication
(10) Pub. No.: US 2002/0086269 A1
(43) Pub. Date: Jul. 4, 2002

(54) Spoken language teaching system based on language unit segmentation

(76) Inventor: Zeev Shpiro, Ra'anana (IL)

Correspondence Address: David A. Hall, Heller Ehrman White & McAuliffe LLP, 7th Floor, 4350 La Jolla Village Drive, San Diego, CA, 92122-1246, US

(21) Appl. No.: 10/023,519

(22) Filed: Dec. 18, 2001

Related U.S. Application Data
(60) Provisional application No. 60/256,537, filed on Dec. 18, 2000.
(60) Provisional application No. 60/256,557, filed on Dec. 18, 2000.
(60) Provisional application No. 60/256,558, filed on Dec. 18, 2000.
(60) Provisional application No. 60/256,560, filed on Dec. 18, 2000.

(51) Int. Cl. G09B 19/00

(52) U.S. Cl. 434/156

(57) ABSTRACT

A computer assisted learning system includes a presentation device that reproduces audio information to provide an audiovisual presentation for perception by a user and includes a presentation speed selector that controls speed of the audiovisual presentation, wherein the audio information includes spoken words and the presentation speed is controlled by the speed selector in accordance with an adjustable language units per minute presentation speed of the audio information. User oral responses to trigger events are recorded, and language unit segmentation is performed to identify language units of spoken words in terms of their phonetics, pitch, duration, and energy, from which user errors in phonetics, stress, rhythm, and intonation may be identified. In another aspect of the system, corrective feedback is provided to guide the user in changing the user's oral responses to provide correct spoken responses.

### REFERENCE TO PRIORITY DOCUMENT

This application claims priority of co-pending U.S. Provisional Patent Application Serial No. 60/256,557 entitled “Spoken Language Teaching System Based on Phonetic Segmentation” by Z. Shpiro, filed Dec. 18, 2000. Priority of the filing date of Dec. 18, 2000 is hereby claimed, and the disclosure of the Provisional Patent Application is hereby incorporated by reference.

### BACKGROUND OF THE INVENTION

1. Field of the Invention

This invention relates generally to computer-assisted teaching systems and, more particularly, to spoken language teaching systems that identify language units in speech for presentation control and for identification of user errors in reference to the language units.

2. Description of the Related Art

It is known to vary the playback speed of audiovisual materials in accordance with a desired playback speed relative to an original, or non-adjusted, speed of the source audiovisual material. This is particularly useful in language instruction for listening comprehension, where a user who speaks one language is being trained to speak in a target language. For example, PCT International Application No. WO 98/44483 to Shpiro et al. describes a language instruction system in which a digital audiovisual playback apparatus provides increased and decreased playback speeds while maintaining audio-to-video frame synchronization and while maintaining audio quality. The system described in the Shpiro document maintains audio quality by recognizing that an audio track of audiovisual material typically includes portions with silence and portions with sound, such as spoken words, and then by differentially adjusting the silent portions and the sound portions. That is, the system identifies sound portions of the audio track that contain recorded sound information, and identifies silent portions of the audio track that do not contain recorded sound. The system then advantageously adjusts playback of the audio track portion by speeding up or slowing down the sound portions by a different proportion than the silent portions.

For example, as described in the above-referenced Shpiro document at FIG. 7 and at page 17, the sound portions (typically comprising words or phrases) and the silent interval between such words and phrases are extended by different time factors. Signal processing techniques, such as the known “WSOLA” technique and the “ETSM” technique, are used to maintain voice pitch of the extended audio track and thereby maintain audio quality. Thus, to slow down an audio track for easier listener comprehension, words and phrases in the audio track may be played at two-thirds speed (so that a block of 0.5 seconds of speech in the original track will require 0.75 seconds during playback), and the silent interval between words may be played at one-half speed (so that 0.5 seconds of silence will be increased to 1.0 seconds of silence during playback), all the while preserving the original voice pitch of the audio track.

The system described in the above-referenced Shpiro document thereby assists language learning and listening comprehension by adjusting playback speed of language instructional materials to a speed with which a user is comfortable, while maintaining audio playback quality by providing constant pitch. In addition, the Shpiro system maintains synchronization with any existing video frame track of the instructional materials. Other computerized language instruction systems are known. For example, U.S. Pat. No. 5,487,671 to Shpiro et al. describes a computerized system for teaching speech in which a user speaks into a recording device in response to a trigger event, and the user's response is then analyzed using speech recognition techniques. Other computer-based language instructional systems also provide practice in pronunciation and fluency, such as described in PCT International Patent Application No. WO 98/44483 and WO 98/02862.

Such systems typically assess user performance to identify when a user's spoken response does not match a desired performance. The assessment usually involves comparing the user's performance against a desired or exemplary performance in the target language. In response to an identified user error, the system will repeat the desired performance for additional practice by the user. Such systems provide corrective feedback by identifying the user pronunciation error and providing an explanation of the desired pronunciation in the target language, and also exercise a user's listening comprehension by presenting audiovisual material in different difficulty levels and providing supportive elements according to the user comprehension level.

Thus, many of the computer-assisted instruction systems provide spoken language practice and feedback on desired pronunciation. Most of the practice and feedback are guidance on a target word response and a target pronunciation, wherein the user mimics a spoken phrase or sound in a target language. For example, in typical computer-assisted instruction systems, teaching vocabulary consists of identifying words, speaking the words by repetition, and practicing proper pronunciation. It is generally hoped that the student, by sheer repetition, will become skilled in the proper pronunciation, including proper stress, rhythm, and intonation of words and sounds in the target language.

Users would benefit from corrective feedback that helps the user understand what variation in pronunciation would produce the desired spoken word. It is known, for example, that spoken words or phrases may be segmented into language units such as phonemes, syllables, tri-phones, and other similar language constructs. The language units of spoken words may also be characterized in terms of their phonetic characteristic, pitch, duration, and energy, from which parameters such as stress, rhythm, and intonation may be identified. Although pitch and energy are known to assist in language instruction, other aspects of phonetic analysis are not typically utilized.

From the discussion above, it should be apparent that there is a need for computer-assisted instruction in spoken language skills that utilizes information retrieved from a user's spoken responses and analyzed in reference to language units, to provide instruction that will assist the user in moving from a produced sound with error to a desired sound. The present invention fulfills this need.

### SUMMARY OF THE INVENTION

In accordance with the invention, a computer-assisted language learning system reproduces audio information to provide an audiovisual presentation for perception by a user and controls speed of the audiovisual presentation, wherein the audio information includes spoken words and the presentation speed is controlled in accordance with a language unit(s) segmentation from which the user may select an adjustable language units per minute presentation speed of the audio information. The playback control may specify the number of language units (e.g. average number of syllables) per unit time and may differentially adjust playback in accordance with the content and/or type and/or difficulty of the audio track and duration of an individual language unit. In a similar analytic manner, the language learning system may receive and analyze the user responses according to a language unit segmentation of the user's responses. In this way, the computer-assisted language learning system utilizes language unit segmentation information contained in an audio information track and retrieved from a user's spoken responses to provide instruction that will assist the user in moving from a produced sound with error to a desired sound.

In one aspect of the system, a user oral response to a trigger event is received, and analysis of the oral response is performed in reference to a language unit segmentation to identify elements of the user's spoken response in terms of the phonetic, pitch, duration, and energy, from which user errors in stress, rhythm, and intonation may be identified. In another aspect of the system, the language unit segmentation is used to provide corrective feedback that will guide the user in changing produced phonetic sounds in the user's oral responses and will help the user provide correct spoken responses.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram of an interactive language teaching system server constructed in accordance with the present invention.

FIG. 2 is a block diagram of a stand-alone computer system that implements the processing of the language teaching system components illustrated in FIG. 1 and FIG. 2.

FIG. 3 is a block diagram of a network implementation of the language teaching system illustrated in FIG. 1.

FIG. 4 is a block diagram of an alternative network implementation of the language teaching system illustrated in FIG. 1.

FIG. 5 is a block diagram of another alternative network implementation of the language teaching system.

FIG. 6 is a graphical representation of the language teaching system being used to provide phonetic-based speech processing in accordance with the present invention.

FIG. 7 is a block diagram of an exemplary computer device that may be used in the systems illustrated in FIG. 1 through FIG. 5.

### DETAILED DESCRIPTION

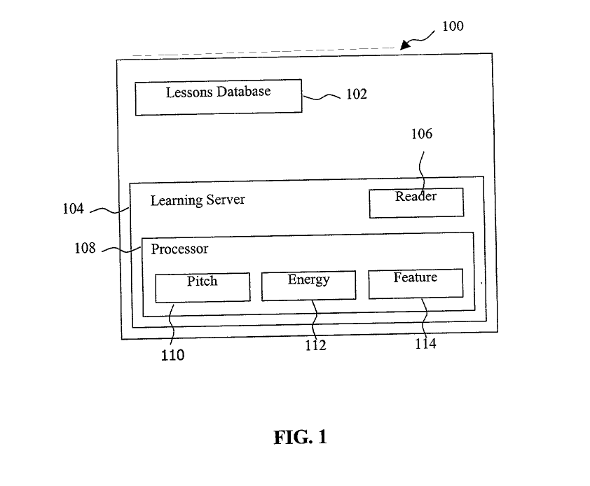

FIG. 1 is a block diagram of a system 100 that provides interactive language instruction in accordance with the present invention. The system includes a lessons database 102 from which a learning server 104 retrieves lessons in a target language for delivery to a user. The learning server includes a reader 106, which receives audiovisual material for presentation to the user. The learning server 104 also includes a processor 108 that receives user spoken input responses and performs an analysis of the user's response. A speed selector controller 109 can be set by the user to control the speed at which the audiovisual information is presented to the user. A more skilled user can set a faster playback speed than a user who is just learning the target language, and a slower speed can be used for newer users and in the case of especially challenging material. As described further below, the processor analyze the user's spoken input using Pitch analysis 110, Energy analysis 112, and Phonetic analysis 114, thereby determining stress, rhythm, and intonation parameters of the user's spoken input.

The language instruction system 100 may be implemented on a stand-alone computer, such as a Personal Computer (PC), such that the language instruction system and user input/output processing are performed on the PC, or the language instruction system may be implemented in a network environment in which language instruction operations are performed on a separate computer from the user's PC.

Stand-Alone PC Implementation

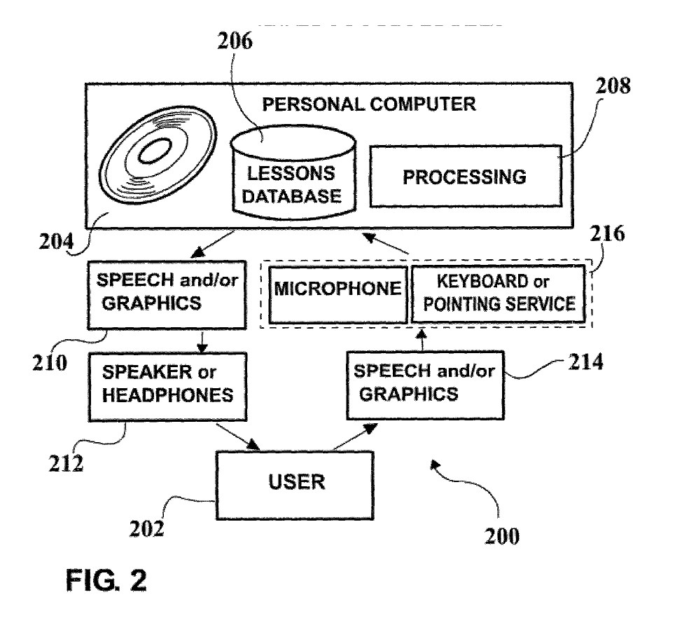

FIG. 2 is a block diagram that shows a stand-alone PC implementation of the present invention, comprising a language instruction computer 200 that performs language instruction operations and at which a user 202 receives instruction and produces oral spoken responses for analysis. The PC implementation includes a PC computer 204 that includes a lessons database 206 and a language processing unit 208 that retrieves language instruction lessons and provides them to the user 202. The language processing unit 208 may comprise, for example, a central processing unit (CPU) that executes appropriate operating system and applications programming to provide language instruction and to present the instruction to the user through speech and/or graphics processing 210, such as appropriate audio (sound card) and display (graphics processing and display screen) units. The audio processing may be reproduced to the user 202 for perception over loudspeaker and/or headphone computer peripheral equipment 212.

When the user 202 receives language instruction over the computer display 210 and speaker equipment 212, the language instruction will include trigger events, such as questions or requests for response. Thus, a triggering device may comprise any device that can produce a visual or audio cue for perception by the user. In response, the user will produce speech and/or graphics input 214 that is received through an input device 216, such as by speaking into a PC microphone and/or using a PC keyboard or display mouse pointing device to provide other input. Appropriate output signals from the microphone, keyboard, and/or display pointing input device 216 will be generated and provided to the PC processor 208. The received user response will then by processed by the language instruction application under control of the language processor 208 in accordance with the invention, as described further below.

Network Implementation

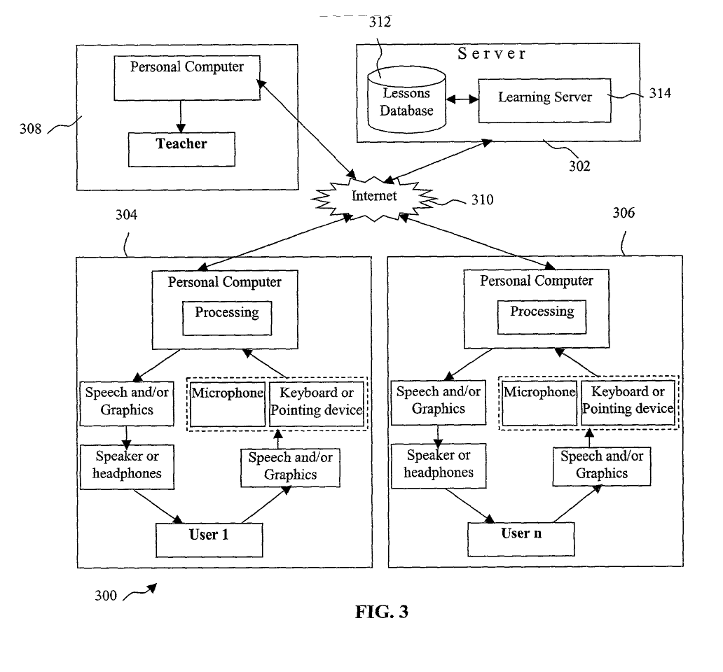

FIG. 3 is a block diagram of a network implementation 300 of the language teaching system illustrated in FIG. 1. A computer 302 operating as a Server computer communicates with multiple users, shown as a first user 304 called “User 1” and one or more additional users 306, shown in FIG. 3 as “User n”. Each of the user computers 304, 306 will typically comprise a PC, to include the input/output elements described above for the PC illustrated in FIG. 2. The Server 302 communicates with the users 304, 306, and also communicates with a teacher 308, over a network 310 such as the Internet. The Server 302 includes a Lessons Database 312 and a computer process Learning Server 314 that retrieves lessons from the Lessons Database and provides instruction to the users.

Each of the PCs has a construction similar to that described above in conjunction with FIG. 2, so that each of the PCs include speech and graphics processors, speaker playback peripherals, keyboards and pointing devices, and a microphone. Thus, each user at a PC can receive an audiovisual presentation, and each user can provide a spoken response to the Server 302. The teacher computer 308 has a construction similar to the PCs of the users 304, 306 and can serve in a lesson management role. That is, the teacher computer 308 can communicate with the server 302 and with the users 304, 306 to help administer tests and exercises, can direct the users 304, 306 to appropriate language exercises, and act as a repository for user information that must be kept secure (such as user performances on language exercises). Finally, each of the user computers includes a processing block, such as described above in conjunction with FIG. 2.

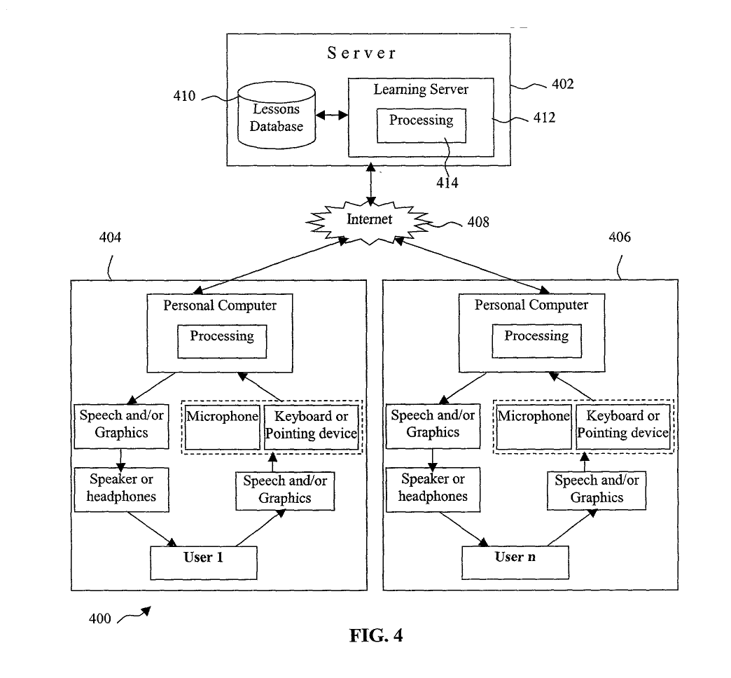

FIG. 4 is a block diagram of an alternative network implementation 400 of the language teaching system. In FIG. 4, there is no teacher computer 308, notwithstanding the fact that FIG. 4 shows a network implementation. For example, FIG. 4 shows that the system 400 includes a server 402 that communicates with multiple users, from a first user 404 called “User 1” through one or more additional users, indicated as “User n” 406 in FIG. 4. As described above, the PCs of the users 404, 406 and the server 402 communicate with each other over a network 408, such as the Internet. FIG. 4 shows that the language server 402 has a construction similar to that of the system 100 shown in FIG. 1, including a Lessons Database 410, a Learning Server process 412, and a processing block 414. Thus, the Learning Server 412 retrieves lessons from the Lessons Database 410 and includes processing that manages the lesson instruction tasks with the users.

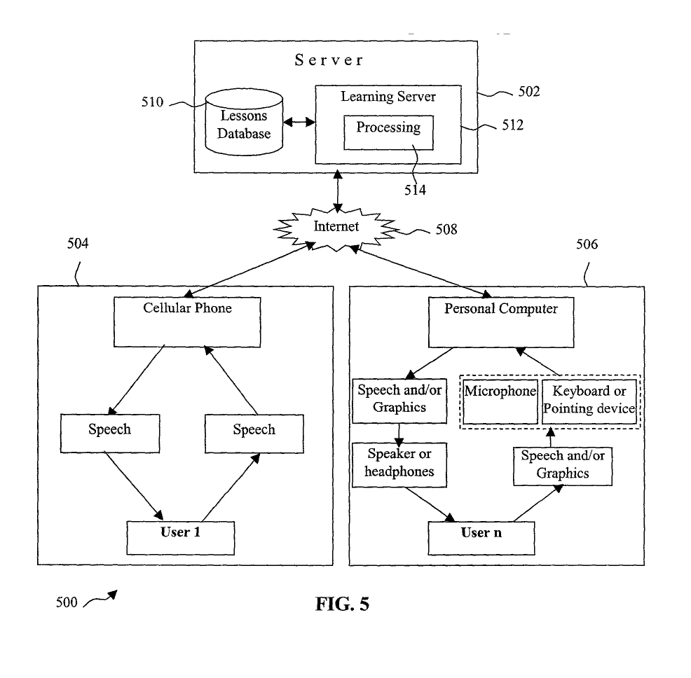

FIG. 5 is a block diagram of another alternative network implementation 500 of the language teaching system. In the system of FIG. 5, a server 502 communicates with users 504, 506 over a network such as the Internet 508. It should be noted that the FIG. 5 system has no teacher computer, such as was illustrated in FIG. 4. In addition, the first user 504 is shown communicating with the server 502 over an electronic device that includes a telephone interface. The telephone may comprise, for example, a cell telephone. It should be understood that the telephone 504 will inherently include speech production equipment (an earpiece or other telephone equipment) and will inherently include other devices such as speech input devices (microphones).

Lesson Delivery and User Response Processing

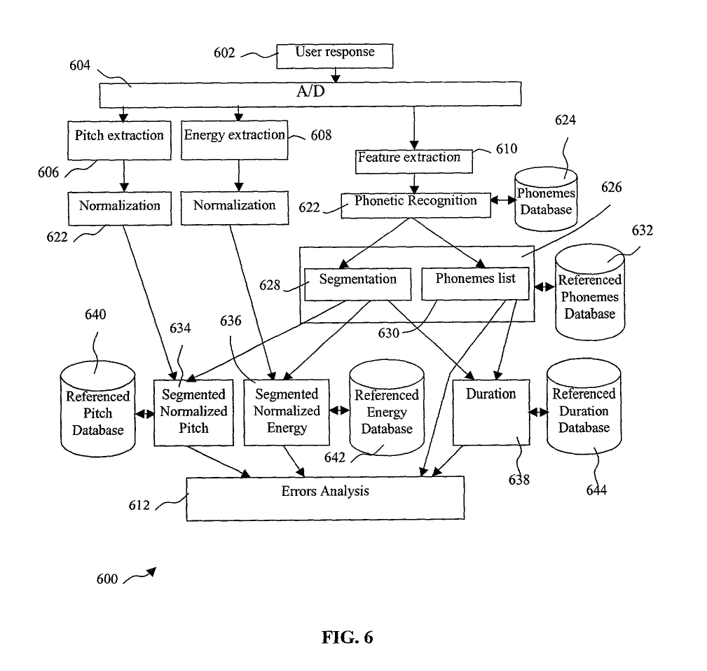

FIG. 6 is a graphical representation of the processing performed by the language teaching system constructed in accordance with the invention. FIG. 6 shows that the system is being used to provide speech instructional processing in accordance with the present invention. Thus, FIG. 6 shows the flow of information and control in a language instructional system, and also illustrates pertinent functional components of the Learning Server described above.

In any system constructed in accordance with the present invention, a user's responses will be received and processed by the Learning Server according to a language unit-based analysis. The following description presents phonemes as an example for the language units, as will be described next. Those skilled in the art, however, will recognize that other language units may be selected for the system, as desired and as will be most appropriate for a target language.

A user's response (a spoken input) 602 will be received from the user's PC microphone and will be provided to an analog-to-digital (A/D) converter 604 for conversion from a voltage signal into a digital representation. In the illustrated embodiments, all speech processing on user inputs is performed in the digital domain, for greater accuracy and consistency. The speech processing is effectuated by program operations comprising a Learning Server software application stored in program memory of the respective processors, whether at the network server or at a user PC or distributed between both. The output from the A/D converter 604 is provided to multiple analysis blocks, illustrated as a pitch extraction block 606, an energy calculation block 608, and a feature extraction block 610.

After the spoken response is analyzed by the pitch extraction 606, energy extraction 608, and feature extraction 610, additional processing, as later will be described, is performed followed by an errors analysis processing 612 that is performed to identify errors in the spoken response. The identified errors are processed by the Learning Server and then a feedback process 614 generates recommended changes in the user's spoken response to help the user generate more correct pronunciation. In the preferred embodiment, the learning server feedback comprises corrective instruction in terms of the identified errors rather than in terms of the target speech characteristics. For example, the identified error may comprise pronouncing the English letter “L” as an “R”. Rather than simply admonish the user to pronounce the letter “L” using a certain mouth and tongue movement that should produce the desired sound, the Learning Server will process the response and the system will inform the user that, for example, “The spoken response sounded like Lice instead of Rice. You are confusing L with R. Instead of sticking your tongue up behind your front teeth, curl your tongue back and let the air out, RRRR”. Thus, the instructional feedback is presented in terms of the identified error. The feedback 614 provided by the system may then provide additional information relating to how the user may change his or her pronunciation from what was received by the computer to what is desired in the target language.

For the spoken response analysis, the pitch extraction block 606 produces a pitch normalization value 618 for the spoken response, whereas the energy extraction block 608 produces a loudness normalization value 620. Those skilled in the art will understand that “energy” of a spoken response refers to loudness of that response. Those skilled in the art also will understand how conventional techniques may be used to derive pitch and energy (loudness) information from spoken information.

The feature extraction block 610 produces phonetic recognition information 622 that is used to analyze the user's spoken response, after checking a phonemes database 624 for similarities between features of the stored phonemes in the database 624 and features of the user's response. Those skilled in the art will understand conventional processing techniques to identify phonetic components in a user's spoken response. If desired, the Feature extraction and Phonetic Recognition also can be applied to the language instruction audiovisual presentation materials, in preprocessing operations before playback to the user or on-the-fly immediately prior to playback, to generate a set of data that can be used for playback control, wherein the speed of playback is controlled as described above. The remainder of the processing description will be described with respect to the user's spoken response, but those skilled in the art will understand that such processing applied to whatever verbal information is presented for processing.

After the user's spoken response has been analyzed at block 622 to identify phonemes, the phonetic information is provided to a phoneme segmentation block 626, which includes a segmentation block 628 and a phonemes list 630. The segmentation block and phonemes list generate data comprising a phoneme segmentation and a list of phonemes, respectively, that are contained in the user's spoken response. Both sets of data are accomplished by checking values from a reference phoneme database 632 against corresponding values of a user's response.

The output of the segmentation block 628 is provided to a segmented normalized pitch processor 634 and a segmented normalized energy process 636. The output of the segmentation block 628 is also provided to a duration block 638 for processing. The segmented normalized pitch processor 634 identifies pitch deficiencies in the user's spoken response by comparing information from the segmentation block 628 and the pitch normalization 618, to identify pitch characteristics of the user's spoken response, against what is found from searching a referenced pitch database 640. Similarly, the segmented normalized energy process 636 identifies energy (loudness) deficiencies in the user's spoken response by comparing information from the segmentation block 628 and the duration processing 638, to identify energy characteristics of the user's spoken response, against what is found from searching a referenced energy database 642. Finally, the duration process 638 identifies any duration deficiencies in the user's spoken response by comparing information from the segmentation block 628 and the phonemes list 630, to identify duration characteristics of the user's response, against what is found from searching a referenced duration database 644.

After the segmented normalized pitch processor 634, the segmented normalized energy process 636, and the duration process 638 processing are completed, the errors analysis block 612 combines information from these processes, along with phoneme information from the phoneme segmentation block 630, to identify a full complement of spoken errors in the user's response. As noted above, the errors analysis information is then provided to a Learning Server feedback process 614 and corrective feedback, tailored to the pitch, energy, and duration errors noted in the user's spoken response, is provided to the user. Thus, the system provides corrective feedback that indicates how the user may correct errors in their user response with respect to pitch, energy, and duration. The user is therefore able to receive a rich, full description of the type of errors being made in spoken responses, and therefore should be better able to correct the spoken response.

Playback Speed Control

At any time during presentation of the audiovisual material, the user may adjust the presentation speed by adjusting the speed control 109 (FIG. 1). The speed control selector may be implemented as an on-screen control or a device control, such as described, for example, in the above-referenced PCT International Application No. PCT/IL/98/00145 to Shpiro et al., which is incorporated herein by this reference. The speed control may be adjusted to account for speaking ability of the user, and for the nature and difficulty of the material being presented for study. For example, the user may select an average speed for presentation playback, expressed in proportion to the “original” or the full recorded speed. Thus, the user may select one-half speed for slower playback, or double speed for faster playback. The speed adjustment will be implemented relative to the originally recorded presentation speed. In accordance with the PCT International Application to Shpiro et al., the pitch of spoken words in the audio track will be maintained substantially constant.

In addition, the system may automatically change the speed of the playback presentation based on the audio track content or audio type. Examples of audio track types are speech, silence, music, singing, sound effects, and the like. An audio track type of singing, for example, may be automatically preserved by the system to remain unchanged from the recorded speed, whereas playback of speech-type audio information may be adjusted in accordance with the user's setting, or with a difficulty type of the audio information. If the system adjusts speed based on audio content, then the system may identify words in the presentation to analyze vocabulary words for difficulty, or may identify other indicators of audio content that the system will respond to by adjusting the playback speed. Thus, the content may be used to adjust the speed of playback, either because of content type (such as singing versus speaking) or because of content material (such as simple or complex information in the spoken text). If desired, data flags for audio information data files may be used to indicate the content type of the audio information, for easier recognition by the system.

In addition, the present invention permits the user to select an adjustable playback speed at a requested number of language units. The number of language units may be specified, for example, in terms of syllables per minute. This is supported through the language unit segmentation analysis described above, which permits the language processor to identify individual units such as syllables (corresponding to known phonetic components of the target language) in words of the audio playback track. For example, the playback speed controller 109 may receive an indicated user playback speed preference for a specified syllables-per-minute of audio playback speed. It should be appreciated that words may be identified as spoken sound surrounded by silent portions. As a result, the system can identify individual syllables within a single word, and can adjust presentation speed within a single word to maintain the speed selection received from the user. Preferably, the system sets the audio track speed and then presents the accompanying video frames in different speeds according to the set speed, such as described in the above-referenced PCT International Application to Shpiro et al. As described above, the system can make automatic adjustments to presentation speed in response to audio content where content includes nature, type, and so forth.

Thus, for a selected syllable-per-minute playback speed, a video presentation that was recorded with a relatively fast original speech track will be slowed down when being played, while another video that was originally recorded with slow speech will be accelerated when played, for the same syllable-per-minute speed selection by the user. Those skilled in the art will be readily familiar with the syllable-per-minute measurement, which is a well-known term in language instruction. The presentation speed selector 109 may be implemented as a mechanical slider switch on a computer peripheral device, or may comprise a “virtual” control slider that is manipulated by the user in a computer on-screen control. In either implementation, the speed control 109 controls speed of the playback presentation and adjusts the pitch of spoken words and phrases in the audio information to maintain the speech quality by substantially preserving the original speech pitch in the presentation material, irrespective of the presentation speed on playback. The playback speed is therefore adjusted in accordance with the content of the audio information.

The present invention thus provides for non-uniform change of playback speed. The playback speed of the video frames and audio track will be adjusted to achieve the set audio playback speed in syllables per minute. More particularly, the described system supports a non-continuous playback function that is continuous and linear in segments (i.e., for a speech phrase there is a given playback speed “A”, a different speed “B” is the playback speed for the following pause, and then the playback speed A is resumed for the following speech interval, etc.). It should be noted that in the above-referenced Shpiro PCT International patent application, for example, the playback speed control treated all of the playback speech as a collection of non-dividable segments, and for such non-dividable segments of speech, there was one playback speed. The system of the present invention provides for automatic speed variation within a single word, such as where one syllable is played slower than another, such that the audio information during playback is maintained in synchronization with visual information.

It is known that linear techniques for speech slow-down on playback, as compared to speed at original playback, will effect speech quality below ⅔ to ½ of the original speech speed. Some nonlinear techniques to achieve such speed control have been recently developed. These techniques change the playback speed during a word or phrase, based on the speech parameters as transitory or stationary. In accordance with the technique described in the above-mentioned PCT International patent application to Shpiro et al., the current invention is especially useful for combining video information with non-uniform speed change of an accompanying audio track. In this way, the present invention provides full synchronization of any frame in the video material to the original sound track. Such synchronization may be achieved, for example, by using the technique described in the above-referenced U.S. Patent Application PCT/IL98/00145. Thus, the speed control 109 maintains synchronization between the audio and visual information during playback.

Phoneme Segmentation Analysis

As noted above, a user's spoken response is processed and its characteristics are defined, in terms of phonetic, pitch, energy, and duration. Such characteristics are important is speaking a language with the minimum foreign-sounding accent. In English, for example, strong and weak stress are defined. In English, every word of more than one syllable has a syllable that is emphasized more than the others. A stressed syllable receives more force and is louder than unstressed ones. Stress patterns go beyond the word level. In English, it is unnatural sounding to stress all the words in a sentence equally or improperly; specific words within a sentence are emphasized or spoken louder to make them stand out. Effective use of strong and weak stress in phrases and sentences is essential to sound like a native English speaker.

In accordance with the present invention, objective parameters (relative to volume (loudness) or energy, pitch, and relative duration of phonemes in the user's phrase) are being analyzed from the user's spoken response to identify the stressed phoneme, syllable, or word in the user's response. A combination of the above parameters with different weight coefficients for each parameter (that can also be zero) was developed to determine the location and “power” of the stress. This analysis is based on a language unit segmentation that is performed prior to the above described process. Thus, the language processing of the system identifies the user mistake and provides corrective feedback on what needs to be done, e.g., the system error analysis identifies a situation where the user may have stressed the first sound (language unit) or syllable in the word “invalid” instead of the second sound--something that changed the meaning of the word from inVAL'id, meaning a value or characteristic that is not correct, to IN'valid, meaning someone physically infirm.

Rhythm also is important in proper pronunciation. For example, the rhythm of conversational English is more rapid and less precise than formal speech. Every spoken sentence contains syllables or words that receive primary stress. Like the beat in music, strong stresses occur regularly to create a rhythm. Certain words within a sentence must be emphasized, while others are spoken more rapidly. This frequency causes sounds to be reduced, changed, or completely omitted. To keep the sentence flowing, words are linked together into phrases and separated by pauses to convey meaning clearly. Effective use of rhythm will help a user to achieve more natural-sounding speech.

In accordance with the invention, the system is designed to support teaching a user and practicing a user's speaking the target language with the proper rhythm. The system flow is composed of the following operations:

a. Triggering the user to say a sentence (with or without background sound representing the rhythm).

b. Receiving and analyzing user response (including subtraction of the background rhythm signal.

c. Developing time base analysis relative to the reference.

d. Identifying user mistake and report to the user.

e. Playing the reference sound with background rhythm signals as hands claps or drums to emphasize the user error.

f. Analyzing user response.

If user error occurs again, the background rhythm is played once again and the user is asked to respond in the same time following the played rhythm. If the rhythm is played via a headset and if the user response is recorded via a microphone, then the processing is as described above. If the background rhythm signal is being played via a PC speaker, then background rhythm signal cancellation is required prior to the speech processing to separate out the user's response from the sounds picked up by the microphone. The cancellation processing may be similar to processing typically being used for telephony echo cancellation applications.

Lastly, it should be noted that intonation is important in proper speaking. Intonation is the pattern of the voice as it rises and falls in speaking. Intonation is very important in expressing the meaning of words (for example, in indicating the type of sentence—a statement, a yes or no question, an exclamation, etc.—is being spoken) and intonation is very important in expressing feelings or attitudes (such as surprise, irony, annoyance, or enthusiasm). The system constructed in accordance with the present invention analyzes intonation based on normalized and segmented pitch, as described above.

The language instruction system in accordance with the present invention may provide for multiple dialects or regional characteristics. For learning English, for example, the target language may be American English, or British English, or a combination of the above. The user may select between them during the language lesson exercise.

The reference databases described above are preferably extended in accordance with a database that is supplemented from non-native speakers that is combined with a database for similar words or phonemes that is constructed from native speakers.

The recorded non-native database may be graded to support different levels of acceptability during the learning process. That is, each level of acceptability defines a different database and therefore defines different models that are built from the database, so that whenever the user selects a required acceptability level, the user repetition is compared to the models associated with the selected level. To implement corrective feedback in accordance with the invention, the user response is modified by correcting the identified mistake in the user's recorded response to reflect the correct way of producing the sound, as should have been said by the user in his or her own voice.

User Response Error Analysis

In this way, many different user response evaluation or analysis modes may be supported. As described above in conjunction with FIG. 6, in general, the error analysis and feedback process includes the following steps:

First, the user's response is subjected to speech model feature extraction. Next, the phonetic analysis and segmentation analysis are performed using a predefined database of phonetic models. Such a database can include, for example, in addition to the phonemes described above, di-phones, tri-phones, and linguistic information. Thirdly, analysis is performed for the characteristics of phoneme duration analysis, pitch extraction, and energy extraction. The system next analyzes and normalizes the pitch information according to the segmentation results. Next, the system builds a relative energy information store and analyzes it according to segmentation results. The system then compares the received results with expected ones (either pre-stored in a data base or built from a database of smaller elements, according to linguistic rules) for identifying pronunciation errors. The system then compares received results with expected ones for identifying stress errors. The system next compares received results with expected ones for identifying intonation errors. And finally, the system compares received results with expected ones for identifying rhythm errors

Computer Construction

The computer that implements the processing of the Learning Server (including the servers and the Personal Computers illustrated in the drawing figures above), or any other computer device of the system, may comprise a variety of processing devices, so long as each device provides sufficient processing power. Such device may include, for example, a handheld computer device, a Personal Digital Assistant (PDA), and any conventional computer suitable for implementing the functionality described herein.

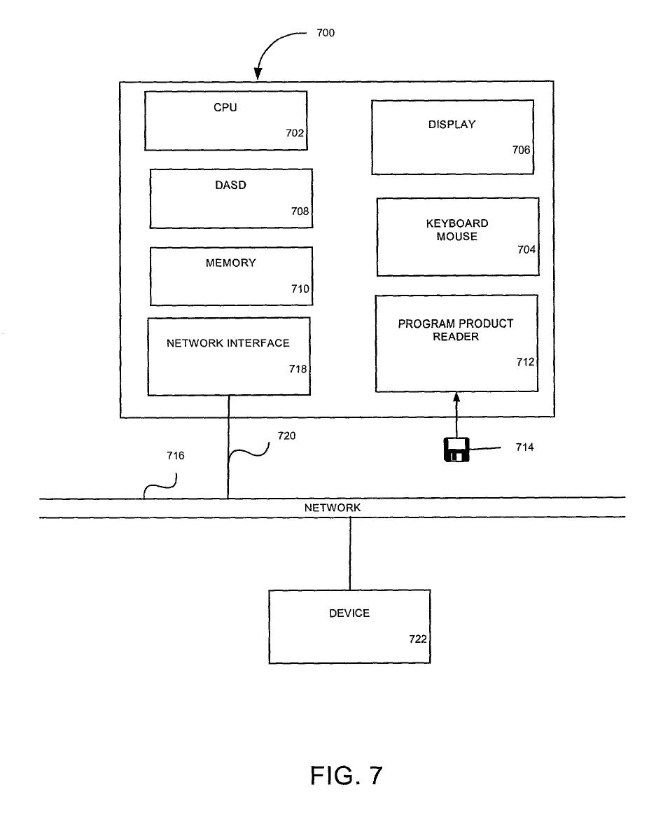

FIG. 7 is a block diagram of an exemplary computer device 700 such as might comprise the PC or the Learning Server computing devices shown in FIG. 1 through FIG. 5. Each computer device operates under control of a central processor unit (CPU) 702, such as an application specific integrated circuit (ASIC) obtainable from a number of vendors, or a “Pentium”-class microprocessor and associated integrated circuit chips, available from Intel Corporation of Santa Clara, Calif., USA. Commands and data can be input from a user control panel, remote control device, or a keyboard and mouse combination 704 and inputs and output can be viewed at a display 706. The display is typically a video monitor or flat panel display device. The user's PC is preferably a voice-enabled device that can receive spoken input from the user, and therefore the user's PC will include a microphone and sound card interface as part of the input peripherals 704, in addition to the keyboard and mouse.

The computer device 700 may comprise a personal computer or, in the case of a client machine, the computer device may comprise a Web appliance or other suitable network communications, voice-enabled device. In the case of a personal computer, the device 700 preferably includes a direct access storage device (DASD) 708, such as a fixed hard disk drive (HDD). The memory 710 typically comprises volatile semiconductor random access memory (RAM). If the computer device 700 is a personal computer, it preferably includes a program product reader 712 that accepts a program product storage device 714, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, a DVD disk, or the like. Semiconductor memory devices for data storage and corresponding readers may also be used. The computer device 700 can communicate with other connected computers over a network 716 (such as the Internet) through a network interface 718 that enables communication over a connection 720 between the network and the computer device.

The CPU 702 operates under control of programming steps that are temporarily stored in the memory 710 of the computer 700. When the programming steps are executed, the pertinent system component performs its functions. Thus, the programming steps implement the functionality of the system illustrated in FIG. 6. The programming steps can be received from the DASD 708, through the program product 714, or through the network connection 720, or can be incorporated into an ASIC as part of the production process for the computer device. If the computer device includes a storage drive 712, then it can receive a program product, read programming steps recorded thereon, and transfer the programming steps into the memory 710 for execution by the CPU 702. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 710 over the network 716. In the network method, the computer receives data including program steps into the memory 710 through the network interface 718 after network communication has been established over the network connection 720 by well-known methods that will be understood by those skilled in the art without further explanation. The program steps are then executed by the CPU 702 to implement the processing of the system.

As noted above, the user's Personal Computer 700 may communicate with other computing devices 722, which may provide the functionality of the servers 302, 402, 502.

The present invention has been described above in terms of a presently preferred embodiment so that an understanding of the present invention can be conveyed. There are, however, many configurations for spoken language teaching systems not specifically described herein but with which the present invention is applicable. The present invention should therefore not be seen as limited to the particular embodiments described herein, but rather, it should be understood that the present invention has wide applicability with respect to spoken language teaching systems generally. All modifications, variations, or equivalent arrangements and implementations that are within the scope of the attached claims should therefore be considered within the scope of the invention.

I claim:

1. An interactive presentation system comprising:
a presentation device that reproduces audio information to provide one of an audio or audiovisual presentation for perception by a user; and
a presentation speed selector that controls speed of the presentation and adjusts pitch of spoken words and phrases in the audio information to maintain the speech quality by substantially preserving the original speech pitch irrespective of the presentation speed;
wherein the audio information includes spoken words and the presentation speed is controlled by the speed selector in accordance with an adjustable number of language units per minute presentation speed of the audio information.

2. An interactive presentation system comprising:
a presentation device that reproduces audio information to provide one of an audio or audiovisual presentation for perception by a user; and
a presentation speed selector that controls speed of the presentation and adjusts pitch of spoken words and phrases in the audio information to maintain the speech quality by substantially preserving the original speech pitch irrespective of the presentation speed;
wherein the presentation speed selector automatically changes the presentation speed in accordance with audio information content being presented.

3. A system as defined in claim 2, wherein the presentation speed selector changes the presentation speed according to a subject matter type of the audio information.

4. A system as defined in claim 2, wherein the presentation speed selector changes the presentation speed according to a difficulty level of the audio information.

5. An interactive presentation system comprising:
a presentation device that reproduces audio information to provide one of an audio or audiovisual presentation for perception by a user; and
a presentation speed selector that controls speed of the presentation and adjusts pitch of spoken words and phrases in the audio information to maintain the speech quality by substantially preserving the original speech pitch irrespective of the presentation speed;
wherein the audio information includes spoken words and the presentation speed selector automatically changes the presentation speed within a word and maintains the audio information in synchronization with visual information during the presentation.

6. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to determine stress errors therein.

7. A language teaching system as defined in claim 6, wherein the learning server process analyzes the determined stress errors to identify stress error characteristics.

8. A language teaching system as defined in claim 6, further including a presentation device that reproduces instruction information to provide a presentation for perception by the user, and wherein the instruction information comprises corrective feedback to the user that is directed to user behavior that will correct the determined stress errors.

9. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to determine rhythm errors therein.

10. A language teaching system as defined in claim 9, wherein the determined rhythm errors are analyzed to identify rhythm error characteristics.

11. A language teaching system as defined in claim 9, further including a presentation device that reproduces instruction information to provide a presentation for perception by the user, and wherein the instruction information comprises corrective feedback to the user that is directed to user behavior that will correct the determined rhythm errors.

12. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to calculate a language units segmentation, normalized measured intonation and determine intonation errors, and graphically present to the user a comparison between the segmented normalized measured intonation against a segmented normalized target intonation, and provide corrective feedback that indicates the user behavior needed to correct the intonation errors.

13. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to determine language units segmentation, phonetic parameters, energy parameters, and pitch parameters of the oral feedback, and to determine any errors therein in reference to the language units segmentation.

14. A language teaching system as defined in claim 13, wherein the system identifies characteristics of any determined user response errors.

15. A language teaching system as defined in claim 13, wherein the system provides corrective feedback to the user that indicates how the user may correct errors in their user response with respect to phonetic duration, energy, and pitch characteristics.

16. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to determine phonetic structure of the user's response, and to determine response language units segmentation, pitch, and energy, and then calculate user pronunciation and prosodic errors of the response by comparing the calculated information to spoken language information stored in a reference data base.

17. A language teaching system as defined in claim 16, wherein the prosodic error analysis includes an analysis of stress, intonation, and rhythm characteristics of the user's response.

18. A language teaching system as defined in claim 16, wherein the system further includes a presentation device that reproduces instruction information to provide a presentation for perception by the user, and wherein the instruction information includes information that is retrieved from a corrective database.

19. A language teaching system as defined in claim 18, wherein the instruction information includes a presentation of corrective feedback to the user that indicates how the user may correct user errors in stress, intonation, and rhythm.

20. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to determine one or more errors in the user's response, and wherein the system further includes a presentation device that produces instruction information to provide a presentation for perception by the user, and wherein the instruction information comprises an indication of any difference in meaning of the user's response as compared to a desired correct response.

21. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to determine one or more errors in the user's response, wherein the system further includes a presentation device that produces instruction information to provide a presentation for perception by the user, and wherein the instruction information comprises a suggested change in user spoken response that will produce a correct user response.

22. A language teaching system that provides instruction to a user, the system comprising:
a learning server process;
a triggering device that triggers the user to provide an input; and
a reception device that receives a spoken input from the user;
wherein the triggering device produces a trigger to which the user will respond to provide oral feedback, and such that the learning server process receives the oral feedback and analyzes the oral feedback to identify a predetermined spoken phrase and to analyze the spoken phrase in the oral feedback for correct phonetic characteristics, and provide results of the analysis to the user.

23. A language teaching system as defined in claim 22, wherein the spoken input from the user is produced in response to user reading of text input.

24. A language teaching system as defined in claim 22, wherein the system further includes a presentation device that produces instruction information to provide a presentation for perception by the user, and wherein the instruction information comprises an identification of the user's response errors.

25. A language teaching system as defined in claim 22, wherein the system further includes a presentation device that produces instruction information to provide a presentation for perception by the user, and wherein the instruction information comprises corrective feedback comprising a suggested change in user spoken response that will produce a correct user response.

26. A computer based method of providing language instruction to a user, the method comprising:
providing a trigger from a computer controlled triggering device to the user;
receiving a spoken input at a reception device, the spoken input comprising oral feedback from the user;
analyzing the oral feedback to determine stress errors in reference to the language unit segmentation; and
reproducing instruction information to provide a presentation for perception by the user, and wherein the instruction information comprises corrective feedback to the user that is directed to user behavior that will correct the determined stress errors.

27. A method as defined in claim 26, further including: analyzing the oral feedback to determine rhythm errors therein.
